(19) United States
(12) Patent Application Publication
(10) Pub. No.: US 2024/0212077 A1
(43) Pub. Date: Jun. 27, 2024

(54) Process to Quantify the Adequacy of a Replacement Reserve Funding Program for Real Property

(71) Applicant: James Dale Comin, chelan, WA (US)

(72) Inventor: James Dale Comin, chelan, WA (US)

(21) Appl. No.: 18/069,419

(22) Filed: Dec. 21, 2022

(51) Int. Cl. G06Q 50/16; G06Q 40/06

(52) U.S. Cl. CPC G06Q 50/163; G06Q 40/06

(57) ABSTRACT

A process to assess and quantify the quality of a reserve funding plan for long term replacement/repairs of real property components via an easily recitable and graspable metric. This process is driven by a computer software application and is employable for common interest development entities, real property with joint ownership, and real property owned by a single entity, if that ownership is a group (i.e. trusts, churches, municipalities or ESOPs), and for other real property. For use by reserve study engineers, property managers, and others, it creates reserve studies for common interest entities. The new metrics that the software produces are useful in the real estate industry for succinct presentation to prospective buyers in assessing the quality of a common interest development which is appurtenant to residential dwelling units, commercial units, or similar, and for other purposes. It replaces a metric which has little value due to a mathematical flaw.

### CROSS REFERENCE TO RELATED APPLICATIONS

This application claims the benefit of U.S. Provisional Application No. 63293595, filed on Dec. 23 2021, which is incorporated herein by reference in its entirety.

### BACKGROUND

### Field of Art to which Invention Pertains

The present invention comprises a computer software application and the output it creates. This embodiment specifically relates to financial management and physical asset maintenance in the real estate industry, particularly comprising that subset of same which is common interest development entities, other entities with joint ownership, and for real property owned by a single entity, if that ownership is a group (i.e. trusts, churches, municipalities or ESOPs).

### Existing Problems and Solutions Created by Invention

Most residential dwellings built in the United States today, and many which have been built over the past few decades, are created as part of common interest developments, which are comprised of condominium associations, planned unit developments, homeowner associations, cooperatives and similar. Due to the nature of these entities' ownership/membership (owners and members are one and the same), their governance and management suffer from a lack of long term stewardship for financial planning related to the replacement and large repairs of their financially prominent shared physical assets, (aka the common elements or capital common elements). These capital common elements are comprised of components of the buildings containing an entity's living units including roofs, siding, gutters and electrical and plumbing systems, and may include appurtenant parks, park equipment, swimming pools, sport courts, fields, fencing, entry gates, park equipment, common buildings and rooms, gyms, recreational areas and other such types of components of the overall physical plant of the entity. The common denominator of all capital common elements is that the maintenance, repair and replacement of each is a shared responsibility between members of the common interest development. This proves onerous to common interest development entities as many problems constrain good long term stewardship of this process.

The ownership composition creates the first challenge. Common interest developments are owned collectively by the members who have purchased units within the entity. This joins together many otherwise unrelated individuals into common ownership of high stakes assets (real estate), often in the multi-million dollar range. They generally do not even know one another at the beginning of the relationship, the time when the initial partnership commences.

Further, the very existence of this business relationship is often not even known by said business partners at the time that they take on ownership within the common interest development entity. And if it is known, it is certainly not the focus of the action which creates the business relationship (the purchasing of a residential unit within a common interest development). Rather, this part of the business transaction of buying a home is peripheral, almost incidental. But it is an integral component of it, and when partaken without proper analysis and care, can lead to deleterious financial consequences.

Moreover, the ownership group is transient, with most entities' ownership composition changing frequently, for some entities each month. In addition to the high stakes of the shared physical assets, each owner of the entity's physical assets also has a great financial stake that is at risk beyond that of the common elements. This is in the value of their appurtenant individually owned living units each of which is generally valued in the hundreds of thousands to millions of dollars. Failure to properly maintain and replace these related common elements can have devastating detrimental consequences to each individual owner's investment in what is often their singularly most valuable asset, their home. Not only is this asset a large part of each owner's financial worth, but is also a large component of their quality of life and nurturing of family, for it is where they often live and raise their families.

The membership size of these entities can range up to thousands of owners. However, in each case, the entity is governed and often managed by a select few, usually 3 to 5 of the owners as members of the entity's board of directors. They are volunteers, usually without experience or training related to their volunteer job as members of the board of directors. Each of these volunteers' tenure generally lasts only a couple of years adding to the lack of continuity. Consequently, such boards may often hire a management firm to which they assign these responsibilities, under their direction. However, continuity is still weak because management company contracts often are year-to-year or even month-to-month, and therefore subject to frequent changes in the contracted partner. And, within a particular management firm, the assigned manager to a common interest development is also subject to frequent change as the industry's employee turnover is high.

Indeed, there are many fracturing elements which combine to create a significant challenge to the long term vitality of common interest developments' real assets. With so many of the stewards of these entities having only short term oversight responsibility, the focus is often on short term rather than long term. There is little incentive to plan for the future, looking 20 to 30 years forward, because most of the custodians of these high stake assets will no longer have ownership or management responsibility by then. The expected life spans of at least some of these components will surely outlive most of the members' ownership in them and most of the managers' management of them.

To summarize the set of challenges created by the composition of the ownership and management:
These entities are owned in common by business partners who have not chosen one another as partners and generally do not even know one another.
The affairs of these entities are administered by a small subgroup of the members, volunteers, generally with little skill or training in this type of administration.
Both of the aforementioned groups' membership composition changes frequently.
The supervision of the long term health of these common elements is often augmented by assignment of outside management companies which are also highly transient in nature.

Largely due to these challenges, one of the greatest failures for these groups is the aforementioned long term planning related to replacement and repairs of the entity's capital assets. These are real property components of a common interest development entity that are owned collectively by such groups.

This problem is exacerbated by the fact that the decision makers often own a very small piece of these common elements as they are shared in common with often hundreds or thousands of others. So, with stakes of often tens or hundreds of millions of collective dollars, each party's interest is diluted, thereby often not garnering the deserved concentrated attention. This all creates a perfect storm for degradation of the common physical assets (common elements) and therefore the financial assets of all of the collective owners in an example of “tragedy of the commons.” Tragedy of the Commons is an economic and social science term described as “when individuals with access to a public resource (also called a common) act in their own interest and, in doing so, ultimately deplete the resource.” To connect the dots, the “individuals” are the entity's owners and in particular the members of their board of directors within the ownership group. The “public resource” is the real property's common elements and the funds held in reserve to maintain them. The term “act in their own interest” would be for the current owners, and/or specifically the members of its board of directors, to disregard the interest of future owners in favor of the current owners, and/or members of its current board of directors. Finally, the term “deplete the resource” would refer to the eventual degradation of the property's common elements due to the lack of funding for their long term repair and replacement in favor of the short term financial advantage for the current owners and/or current members of its board of directors.

For all of these reasons, a process called the reserve study was created decades ago for real property common interest developments. The reserve study report is a long term (typically 30 year) financial plan for repair and replacement of these capital assets.

The reserve study report has, among others, these four primary purposes:
a) To create a schedule for replacement and repair of common components over the 30 year period of the study.
b) To create a funding plan to meet the obligations of (a).
c) To maintain the marketability of the units/homes in the entity to potential buyers by maintaining a reserve funding plan, and employing that plan to ascertain long term repair and maintenance of the capital common elements of the entity, all of this to a level comparable to or better than competing entities (i.e. entities with similar types of units/homes in the same region).
d) To maintain an equitable balance in the funding of the reserves between current owners and future owners.

The question is how to quantify whether these goals are being met. The first attempt to do so, using the percent funded metric, has failed.

How important is it to create a better way? Let us look at the prevalence of reserve studies. Of all common interest development sub sets (i.e. Condominiums, Planned Unit Developments, Homeowner Associations and Cooperatives) condominiums are at the forefront in developing requirements related to reserve studies and reserve funding. There are currently at least 11 states which require reserve studies (or similar) to be completed for condominium associations. Many others offer guidance within their statutes related to reserve studies and reserve funding. Only 11 states have neither statutory requirements nor statutory guidance related to reserve studies and or reserve funding for condominiums. (Related information is in document #1 on the Non Patent Literature Documents form included in this submission). Additionally, most common interest developments' own recorded declarations have some type of requirement which must be met with regard to reserve studies and/or reserve funding

To speak to the prevalence of common interest developments, estimates are that over 350,000 common interest developments exist in the US which are heavily concentrated within the aforementioned 39 states (with statutory requirements or guidelines related to reserve funding), and even more so within the aforementioned 11 of those 39. As of 2019, about 74 million people lived in common interest development communities in the United States. These numbers have significantly increased since 1970 when there were an estimated 10,000 such communities housing an estimated 2.1 million people. (Related information is in document #2 on the Non Patent Literature Documents form included in this submission).

Much spotlight was shined on the importance of the reserve study and reserve funding when a building collapsed in Florida in June of 2021 and one of the causes appeared to be lack of proper maintenance due to lack of reserve funding for same (related information is in document #3 on the Non Patent Literature Documents form included in this submission).

So, the reserve study industry is quite important and quite large as attested to by creation of two separate and distinct national trade organizations for the purpose of managing and regulating the industry.

To drill a bit deeper on the reserve study report product, as mentioned, it prices and charts out, at a point in time, all of the expected common element capital repair and replacement projects over the next 30 years. When that process is completed, a budgeting plan is designed to create the proper monthly funding amount (commonly called the reserve contribution) to be set aside in reserve funding in order to adequately meet these future expenditures at the time necessary. This process then allows “equalized funding” to be collected from owners each month over the years (with an inflation factor). The creation of the reserve study introduced other new nomenclature as well. The studies offered terminology such as fully funded balance (the amount at a given point in time that should be in reserves to cover the “used up” portion of each of the components of the reserve study report), reserve underfunding (the difference between the fully funded balance and the reserve funds on hand), and percent funded (the actual reserve funding on hand as a percentage of the fully funded balance).

Conceptually, the reserve study was a solution to the problem herein described. But, of course, reserve studies are just plans, “best made” plan perhaps. By their very nature they would tend to be imprecise due to their numerous components and subjective process to estimate the timing and costs of their repair and replacement 30 years into the future. And then there are the challenges of projecting inflationary adjustments and returns on investment of reserve fund balances over that long of a time period. Due to such vagaries afflicting these reserve plans created by the reserve studies, they could never be perfect. These imprecisions may contribute to the fact that these plans have not being held as sacred, and no national or state laws actually require such sanctitude. There are laws which require their creation but the laws are largely silent as to the actual process by which they are to be created. And laws related to implementation of these plans, as created are also scarce.

Something that is imperfect by nature is less criticized for additional imperfections and they can easily go unnoticed. And a process that starts with a flaw cannot overcome the flaw by delivering near perfection in the completion of the steps within that process. Therefore, the flaw with the percent funded metric has persisted.

Further, due to the ongoing attrition of the decision makers, there is often a desire to veer from the plan (i.e. save money for the current owners, including themselves, by funding the reserves at less than the fully prescribed funding, and make it up later). So quite often, common interest developments do not fund according to the funding plan set forth in the reserve study report. But at least with the reserve study concept, there was theoretically, a way to determine a relationship between the necessary funding level, as calculated, and the actual funding level for an entity at any point in time. The aforementioned term reserve underfunding became ubiquitous in the industry to describe a common interest development's reserve funding inadequacy.

But reserve underfunding is a dollar amount held as a collective liability among all of the owners. It seems it was quickly, and sensibly, determined that this didn't really tell the full story. The magnitude of a particular underfunding amount was greater for larger entities than the same amount was for smaller entities. For example, an underfunding of $100,000 to a 10 home community was a much larger relative burden than it was to a 1,000 home community. The first logical solution to this problem was to turn it into a percentage. The logical percentage, ostensibly, was the actual amount funded as a percentage of the theoretically correct funding amount. So, the term percent funded was borne to measure this. Unfortunately, when conceived and to this date, this metric has a mathematical flaw. The math is inherently sound, but the application in this situation is not, creating the flaw. This flaw is material and undermines the veracity of the entire reserve funding process, giving false reads to millions of homeowners across the country which often results in negative and sometimes devastating financial consequences. The flaw is that this process compares one number which always accurately indicates the liability at a given time (the amount of the reserve underfunding) to a number which, by its nature, varies capriciously year to year (the fully funded amount). Why? Because the fully funded amount has a secondary influencer which causes unreliable results. This secondary influencer is the chronology of the projects drawing from this fund. For example, if an entity had a fund balance of $300,000 when the fully funded balance was set at $600,000, it is only 50% funded. If it then spent $100,000, the fund balance drops to $200,000 ($300,000 minus $100,000) while the fully funded balance drops to $500,000 ($600,000 minus $100,000). While the deficit ($300,000) and the adequacy of the funding remains exactly the same, the percent funded drops from 50% to 40% (200,000 divided by $500,000). These percentages need to remain the same if it is to be an accurate assessment of the reserve fund's adequacy. But principles of math will not allow that. This creates an insurmountable flaw. This flaw is exacerbated by the fact that it is veiled in several ways; 1) the 30 year long term that each reserve study report is designed to run; 2) the fact that the reserve funding amounts are buried as only one of dozens of expenses that are included in the fee charged to each owner via monthly assessments, and of all of the expenses, it is the most difficult for the layperson to understand; 3) the error is “trued up” frequently, usually every year or two (often depending on the frequency dictated by state law), breaking the magnitude into small pieces which are much less discernable. Even so, the corrected version creates the same error for the present and the future, while correcting the past error. This usually all occurs before truly devastating effects manifest, therefore, few ever even notice its drip affect which is far from nominal. The effects of this error are completely avoidable.

Despite the flaw in accuracy, percent funded has become the standard method to describe the adequacy of a reserve fund. It is erroneously embraced by the laws of many states, the two trade organizations which have been created specifically to govern the reserve study industry, and by virtually every one of the hundreds of companies created to prepare reserve studies. It is really the exclusive metric in regular use today for describing the adequacy of a reserve fund and has become a standard, albeit unsound, term when individuals discuss the adequacy of an entity's reserve plan. One final important note is that even if the percent funded metric accurately performed its purpose, its assessment of adequacy is difficult to understand because, a percentage standing alone without perspective, has little value. Using the percent funded vernacular, a reserve fund may be funded at 65%, but unless one draws some relationship to what is normal, what is good, or what is poor, it doesn't offer much guidance.

This invention solves these problems with a new software application which creates reserve studies whose output is a metric which accurately measures the adequacy of a reserve funding program and which metric is intuitively processable by laypersons and professionals alike.

### SUMMARY OF THE INVENTION

As just stated, the current invention is for a process to create, via a software application, a new type of reserve study which is better able to quantify the quality of the reserve funding program via a greater breadth of more accurate criteria. Further, it creates new metrics for the purpose and a grading summary which is more understandable to the layperson, of which many associated with the product are. The initial embodiment was designed to correct the flaw as it relates to reserve planning for common interest development entities comprised of condominiums associations, planned unit developments, homeowner associations, real estate cooperatives and others. However, it applies to any real property which has joint ownership where the individuals have a right to sell their piece of ownership, and even for real property owned by one entity, particularly if that ownership is on behalf of a group (i.e. a trust, a church, a municipality, an ESOP, or other such entities).

This invention may be used by reserve study creators, engineers, property managers, accountants, financial planners, and others, to create reserve studies for those entities earlier described. It may also be used by said entities' managers, board members, accountants, employees and owners of the entity, as well as potential future owners of the entity (i.e. prospective buyers), financial institutions and real estate professionals in assessing the health of a common interest development which is appurtenant to a particular residential dwelling unit, commercial unit, or other similar units, as well as for other purposes. It would replace or augment the aforementioned existing percent funded metric. Percent funded calculations could still be used as a supplemental metric, but should not be used to the end of qualifying the adequacy of a reserve fund. This invention eliminates the flaws of that method through the creation of new, unflawed, and precise metrics, thus making the output usable for the originally designed primary purposes of a reserve study.

As another feature, the invention allows for objective quantification and recital of these new metrics with logical, easy to comprehend classifications, through a “grading” system (with a range of A+ to F−). This grading system converts the accurately descriptive, but difficult to comprehend, mathematical metrics of this invention into friendlier terms for the layperson. There is innate understanding that an A+ rating means that something is good, or in this case that a fund is strong, while, for instance a C rating inherently implies a lower quality, or in this case a weaker funding program. This compares to the current standard measurement, percent funded, which as we mentioned earlier, does not offer any clues as to the strength of a funding program, standing alone. Is “65% funded” good? Neither inherent logic nor life experience can answer that. If a professional baseball player gets a hit in 65% of his at-bats, he is the greatest player in the history of the game, while if a professional basketball player makes 65% of his or her free throws, that is subpar, inadequate. A percentage standing alone does not speak to adequacy. Expressing the adequacy of an entity's reserve funding program utilizing percent funded nomenclature is similarly inconclusive, standing alone. It is very difficult or impossible to know what the percentage means.

This failure is further exacerbated by another confound to the percent funded metric. That is that it's meaning is inconsistent. Even within the confines of reserve studies' percent funded metric, a 65% funding level is better in some cases than others. Furthering the inadequacy of this metric and rendering it quite nonsensical is the fact that, though 65% is sometimes better than 50%, which is logical, sometimes quite illogically and incredibly, 50% is better than 65%, proving the term percent funded to be ineffective and quite useless. It suffers the same contradiction disorder as the English language word, “bimonthly” which can mean either a) occurring twice a month or b) occurring every two months. The “bimonthly” contradiction is often innocuous but could create problems. In the case of the percent funded contradiction, the creation of problems is, over time, generally inevitable. The current invention remedies this entirely.

### BRIEF DESCRIPTION OF THE DRAWINGS/FIGURES

FIG. 1 This is an output report of the invention which shows the key metrics of the invention's reserve program's adequacy assessment, including the ^{e}grade, its ranking, the fund's trajectory and the projected year of fund depletion. These figures are the most essential of all of the data created by the invention, are a summary of the processing of extensive data, yet the simplicity of presentation is obvious. This table also capture much of the novelty of the current invention, and is the primary data for proclamation of adequacy of a reserve fund. (The bolded numbers and bolded words in this figure are dynamic, created for a particular entity by calculations performed by the software application of this invention)

FIG. 2 This is an output report created by the software application which illustrates the sub-metrics that are created by the invention and feed into the calculation that creates the ^{e}grade and the funding trajectory of FIG. 1. Additionally, the output compares each of these sub-metrics for the subject entity to the other entities that have been assessed and are captured in the application's data base, offering a comparison to the highest of each, the lowest of each, and the average of each and then shows the ranking of the subject entity with the other comparative entities for each category. (The bolded numbers and bolded words in this figure are dynamic, created for a particular entity by calculations performed by the software application of this invention)

FIG. 3 This is an output report created by the invention which illustrates the internal data for the entity that feeds into the calculation that creates the Urgency of Deficit & Reserve Projects' Imminency, as well as the Depletion Year. (The bolded numbers and bolded words in this figure are dynamic, created for a particular entity by calculations performed by the software application of this invention)

### DETAILED DESCRIPTION

This current invention creates, via a software application called ^{e}thereal, a letter grade by combining four important metrics each of which accurately quantifies the adequacy of an entity's reserve funding program. The amalgamation of the 4 sub-metrics becomes the key assessor, or primary metric, which is called the ^{e}Grade. Each of the four sub-metrics are ways to describe the deficit in a reserve fund, by comparing the amount that it is underfunded to logical, comparative and appropriately consistent data (as opposed to capriciously dynamic data which creates the fully funded balance), as used to determine the percent funded metric which is in pervasive use today). After combining these four criteria, ^{e}thereal grades on a curve and compares each entity's ^{e}Grade to those of other entities. The top 20% score in the “A” range, with the top ⅓ (of the 20%) garnering an “A+”, the next ⅓ an “A”, and the bottom ⅓ an “A−.” This same process continues on to the other typical grading letters as shown on the chart below:

ethereal's ^{e}Grade Conversion Table

>93.3%: A+
>86.7%: A
>80.0%: A−
>73.3%: B+
>66.7%: B
>60.0%: B−
>53.3%: C+
>46.7%: C
>40.0%: C−
>33.3%: D+
>26.7%: D
>20.0%: D−
>13.3%: F+
>6.7%: F
<6.7%: F−

In addition to these banded scores, where several entities would score the same, we offer a way to identify an entity with much more specificity by showing exactly what position they rank as compared to all entities which have been rated, for example “12^{th} out of 300”. This gives every entity assessed a unique rating.

All four of the sub-metrics are created by starting with the amount (in dollars) of the underfunding in the reserve fund and comparing it to other data. This is the necessary process for the conversion of a dollar amount into a percentage, thereby creating a common denominator for all entities, whether similar in size or not. This percentage can be appropriately applied to any such entity, without skew. This is important because being underfunded by a particular dollar amount is a different burden for different entities, relative to the size of the entity. Here the term “size” refers to both the financial amplitude, and the number of units within the entity who share the underfunding liability. The four sub-metrics are detailed in the following paragraphs.

Metric #1: Deficit to Asset Value Ratio. The first metric draws a comparison between the reserve fund deficit and the full current value (as opposed to the depreciated value, and as opposed to the original value) of the “reserved for” assets. This is a very logical comparison because it compares the reserve underfunding (which is effectively the debt for maintenance of the assets) to the value of said assets. As an example of this Deficit to Asset Ratio, if an association's assets are worth $10 million (in new condition) and its reserves are underfunded by $1 million, it's Deficit to Asset Value Ratio would be 10% ($1 million divided by $10 million). This is analogous to the equity in a home since such equity is calculated by taking the assessed value of a home and subtracting the amount of its mortgage. Though that computation returns a dollar amount, it could easily be stated as a percentage (Home value: $300,000, Mortgage is $100,000, the owner has 66.7% equity in his home). In the reserve fund, the reserve underfunding is, in essence, a debt to the current and future owners of the entity and is a liability against the value of the assets of the common components of the entity.

This ratio sounds strikingly similar to the flawed and currently pervasive percent funded ratio, but it is not at all similar. Both start with the reserve funding deficit, but the percent funded methodology compares it to the hypothetical fully funded balance, while the Deficit to Asset Value Ratio compares it to the full value of the entity's reserved for assets. The fully funded balance is a dynamic number which changes regularly, and is largely independent of the adequacy of an entity's reserve fund, throughout the 30 years of a reserve study. This makes it a poor number from which to draw a relative comparison. The reserved for assets, on the other hand, is static except for inflationary adjustments making its use valid in describing the relative size of a reserve funding program, thereby giving reliable relativity to the amount of the underfunding at every point in time.

Metric #2: Deficit to Income Ratio. This metric compares the reserve fund deficit to the entity's annual income. This comparison is logical in that the eradication of the deficit would be effected out of the income. This is analogous to a person's net income being considered in how large of a mortgage they will be granted for a home purchase.

Metric #3: Deficit to Funding Ratio. This metric compares the reserve fund deficit to the association's annual reserve contribution (the annual reserve contribution is the amount of money budgeted each year to deposit into the reserve fund out of the revenue of the entity). This is a logical comparison because it compares what you haven't funded to what you are funding which thereby speaks to the magnitude of the deficit.

Metric #4: Per Unit Underfunding. This metric has been publicly used in the past, standing alone, and not for the purpose of quantifying the overall adequacy of a replacement reserve funding program for real property, but rather as an adjunct to that quantification. This metric is the reserve fund deficit divided by the number of the units in the entity, returning the amount of the deficit which, on average, belongs to each unit. This would be a very valuable detail for a prospective buyer of a unit within an entity as it would apportion a share of the liability created by the reserve underfunding to that individual. The prospective buyer could argue, for instance, if the unit he is considering for purchase “owns” $10,000 of this entity's liability, and he or she may want consideration in the form of an offset to the purchase price or as a credit in the settlement of the sale. This isn't always a precise calculation because sometimes the apportioning of the liability is not equal across all units. But it offers what is generally a close approximation.

One other corollary metric is invented and introduced which tempers the ^{e}Grade metric, and is created by a specific process held within the ^{e}thereal computer application. This peripheral metric is the Reserve fund Trajectory, which is calculated by comparing a fund's current rate of funding to its normalized rate of funding over 30 years (with the term normalized funding meaning the average funding rate, adjusted for inflation, over the entire term of the reserve study). The Reserve Fund Trajectory is an important supplement to the ^{e}Grade because it addresses the trajectory of where the ^{e}Grade is headed over time, at its current funding contribution. Since reserve studies have a 30-year scope, it is vital to speak to the future as well as the present. This trajectory is rated in terms of pluses and minuses per the chart below:

| Rating | Current Periodic Funding Contribution Level |
|---|---|
| Triple plus (+++) | Over 20% greater than normalized funding. |
| Double plus (++) | Between 10% and 20% greater than normalized |
| | funding |
| Plus (+) | Between 0% and 10% greater than normalized |
| | funding |
| Minus (−) | Between 0% and 10% less than normalized funding |
| Double minus (−−) | Between 10% and 20% less than normalized funding |
| Triple minus (−−−) | Over 20% less than normalized funding |

Triple-plus is the most positive condition and each descending designation is incrementally less so. These units of measure are utilized to give logical insights as to whether a fund's trajectory is good or poor by simply referencing its trajectory rating. Despite its great importance, this concept of comparing current funding to long term typical funding levels has not been considered in reserve studies in the past in any quantifiable metric.

Additionally, one more set of peripheral metrics of the invention are introduced within the Urgency of Deficit/Reserve Projects' Imminency, a comparative process which quantifies the imminency of scheduled reserve projects. It offers insights into one other aspect of concern related to any reserve fund inadequacy, the urgency of fixing the inadequacy. A reserve study is a very long term plan, usually 30 years, and the timing of the expenditures over that 30 years can be quite variable. If the expenditures contributing to its inadequacy are more imminent than typical, the correction of the underfunding is more urgent and may require a different path to correction than less urgent deficits which may be created by projects later in the 30 year cycle. So, this comparative process, The Urgency of Deficit/Reserve Projects' Imminency quantifies the urgency by totaling the planned expenditures from the fund over the most immediate two-year and five-year periods of time (from the date the study was created) and expresses them as a percentage of the total volume over the life of the reserve study report period. Therefore, if an entity's project expenditures scheduled over the next two years, for instance, are five percent greater than two times the average annual expenditure throughout the term of the reserve study report period, this would be expressed as a 5% negative variance, while if it is 5% less, it would be expressed as 5% positive variance. In this case less is better and therefore a positive variance.

Finally, as a component of this invention, another peripheral metric introduced is the identification of the year, if any, in which the reserve funds would be depleted reaching a negative or zero balance, called the Depletion Year.

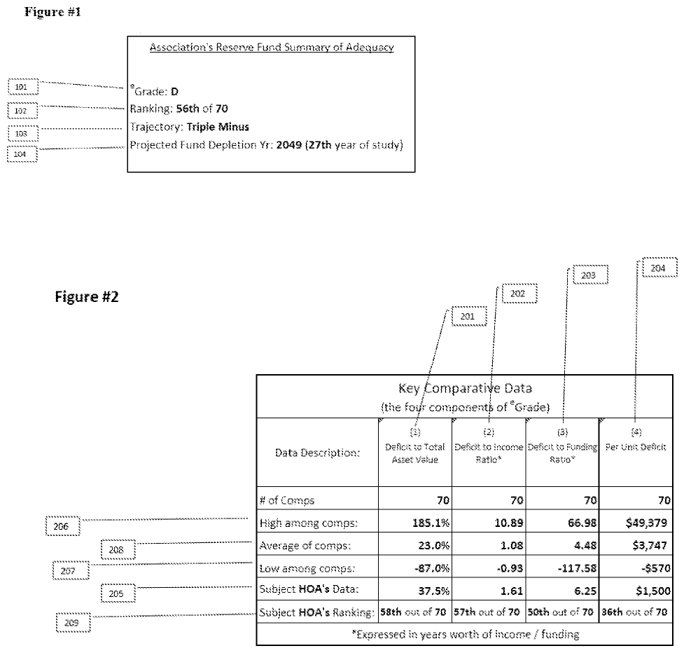

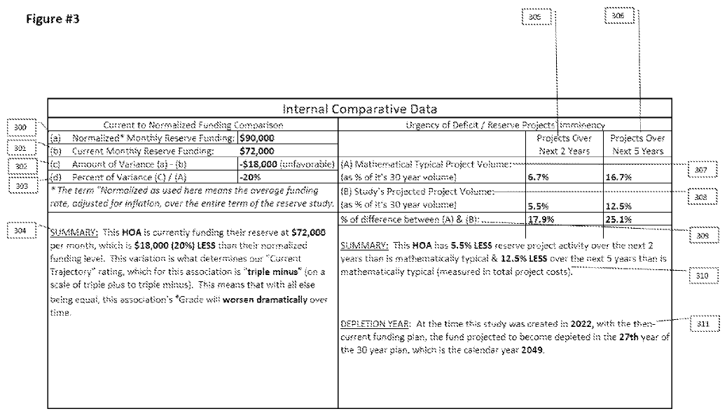

The invention includes a process for the creation of all of these calculations and comparisons via the ^{e}thereal software application. This application will create as an output, a reserve study report, which comprises a report of generally over 50 pages and often up to 100 or more. However, the novelty of this invention rests in only the few key metrics and calculations of the invention's reserve study report output, along with related nomenclature. These key pieces of the invention's current embodiment are comprised of:
1. A report, FIG. 1, depicting the entity's ^{e}Grade 101, ^{e}Grade ranking 102, Reserve Fund Trajectory 103, and the projected Depletion Year 104, (expressed as both calendar year and running year).
2. A report, FIG. 2, showing the four key sub-metrics 201, 202, 203, 204 which amalgamate to create the ^{e}Grade, along with a comparison of each for the subject entity 205 to other entities (those captured within ^{e}thereal's accumulating data base, which accumulates data every time it is deployed for a new entity). Said comparisons include for each metric, a comparison to the highest ranking entity within the data base 206, to the lowest ranking entity within the data base 207, and to the average of all of the entities within the data base 208. In addition, for each sub-metric, it offers the ranking of the subject entity among all of the entities in the data base 209.
3. A report, FIG. 3, which creates insights into the status of the subject entity's reserve funding plan based only on internal conditions and influences within the subject entity. The left side of this FIG. 3 is entitled “Current to Normalized Funding Comparison.” This compares the average prescribed monthly funding over the life of the study 300 and the then-current monthly funding level 301, reporting the variance as both a dollar amount 302 and as a percentage of the average prescribed monthly funding 303. Then it offers a summary and assessment of the effects of the data in narrative format, including the Trajectory rating 304.

The right side of this FIG. 3 is entitled “Urgency of Deficit/Reserve Projects' Imminency” and describes these matters for the subject entity for two distinct time periods. In the current embodiment, these periods are two years 305 and five years 306 (both commencing from the time the reserve study was created). For the two time periods, the report states the typical monthly volume of reserve fund expenditures for the subject entity over the life of the reserve study report 307 and compares that to the projected volume of reserve fund expenditures for the subject entity 308 over the prescribed time periods, two years 305 and five years. It then reports the percentage of the variance between the two 309. Next, the report offers a summary of the data in narrative format 310. Finally, again in narrative format, the report offers the projection based on the data of the reserve study as to when the funds will be depleted, if applicable 311.

1. A process to create an improved reserve study report for common elements of real property comprising: a proclamation as to the adequacy of the reserve funding program addressed in the reserve study through use of a plurality of defining metrics, including a primary metric and several sub-metrics which are components of the primary metric as well as other peripheral metrics; for use in common interest development entities and other real property entities, which entities comprise condominium associations, homeowner associations, planned unit developments, real estate cooperatives, and any other real property which has joint ownership, and for real property owned by a single entity, particularly if that ownership entity is a group comprising a trust, a church, a governmental building or ESOP, among others.

2. A software application, comprising: the creation of the process set forth in claim 1 and other related processes and output.

3. A process, to define the adequacy set forth in claim 1 comprising: an amalgamation of a plurality of metrics, each of which compares the amount of the reserve underfunding to other appropriate financial data for the entity; and which collectively are described in letter hierarchy, ranging from best to worst as A+ to F− and designated as the ^{e}grade.

4. A process, supplemental to claim 3 comprising: the creation of the Deficit to Asset Ratio as a portion of the subset of the plurality of metrics of claim 3, which amalgamate to create the ^{e}grade metric of claim 3.

5. A process, supplemental to claim 3 comprising: the creation of the Deficit to Income Ratio as a portion of the subset of the plurality of metrics of claim 3, which amalgamate to create the ^{e}grade metric of claim 3.

6. A process, supplemental to claim 3 comprising: the creation of the Deficit to Funding Ratio as a portion of the subset of the plurality of metrics of claim 3, which amalgamate to create the ^{e}grade metric of claim 3.

7. A process, supplemental to claim 3 comprising: the creation of Per Unit Underfunding as a portion of the subset of the plurality of metrics of claim 3, which amalgamate to create the ^{e}grade metric of claim 3.

8. A process, as a component of the proclamation of the adequacy of reserve funding program of claim 1 comprising: the creation of the Reserve Fund Trajectory comprised of: the projection of the anticipated change in the ^{e}grade metric set forth in claim 3 as projected 30 years into the future; described in plus and minus hierarchy, from best to worst as triple plus (+++) to triple minus (−−−).

9. A process, as a component of the proclamation of the adequacy of reserve funding program of claim 1 comprising: Urgency of Deficit/Reserve Project Imminency which calculates the relative imminency of upcoming reserve fund expenditures.

10. A process, as a component of the proclamation of the adequacy of reserve funding program of claim 1 comprising: Depletion Year as an adjunct to claim 8 and which identifies a date certain of when the reserve fund will deplete as set forth within the Reserve Fund Trajectory of claim 8.
